(19) United States
(12) Patent Application Publication
(10) Pub. No.: US 2022/0343261 A1
(43) Pub. Date: Oct. 27, 2022

(54) ARRANGEMENT APPARATUS FOR PERSONNEL, ARRANGEMENT METHOD AND PROGRAM THEREOF

(71) Applicant: NIPPON TELEGRAPH AND TELEPHONE CORPORATION, Tokyo (JP)

(72) Inventors: Masahide TAKASUKA, Musashino-shi, Tokyo (JP); Hiroshi YOSHIDA, Musashino-shi, Tokyo (JP); Tomoko SHIBATA, Musashino-shi, Tokyo (JP); Masateru INOUE, Musashino-shi, Tokyo (JP)

(73) Assignee: NIPPON TELEGRAPH AND TELEPHONE CORPORATION, Tokyo (JP)

(21) Appl. No.: 17/762,386

(22) PCT Filed: Sep. 27, 2019
(86) PCT No.: PCT/JP2019/038277

§ 371 Date: Mar. 22, 2022

(51) Int. Cl. G06Q 10/06

(52) U.S. Cl. CPC G06Q 10/063118; G06Q 10/063112

(57) ABSTRACT

An arrangement apparatus (10) includes: an acquisition unit (111) configured to acquire the number of tasks and the number of human resources who address the tasks; a calculation unit (112) configured to calculate a result of arranging the human resources to each of the tasks to Pareto-optimize a first element and a second element, based at least on a first evaluation value related to the first element that is to be emphasized when the human resources are arranged for the tasks and a second evaluation value related to the second element that is an element to be emphasized when the human resources are arranged for the tasks and is different from the first element; and an output unit (113) configured to output an arrangement result calculated by the calculation unit (112).

### TECHNICAL FIELD

The present invention relates to a human resources arrangement apparatus, an arrangement method, and an arrangement program.

### BACKGROUND ART

As a technique for automatically determining an arrangement of human resources to process a plurality of tasks, a technique in PTL 1, for example, is known. According to the technique in PTL 1, an arrangement of human resources is determined such that a time required to finish all tasks is minimized, the number of human resources is minimized, and a variation in total processing time for the tasks assigned to each human resource is minimized on the basis of processing time information representing a processing time for the tasks of each human resource.

### CITATION LIST

### Patent Literature

PTL 1: JP 2017-211921 A

### SUMMARY OF THE INVENTION

### Technical Problem

A plurality of elements which'have to be emphasized may be present in an actual arrangement of human resources. Also, the plurality of elements are in trade-off relationships in which the elements affect each other in many cases. An apparatus capable of suitably arranging human resources even in a case in which such a plurality of elements are present is required.

The present invention was made in view of the aforementioned circumstances, and an object thereof is to provide a human resource arrangement apparatus, an arrangement method, and an arrangement program capable of suitably arranging human resources even in a case in which a plurality of elements to be emphasized in an arrangement of human resources are in mutual trade-off relationships.

### Means for Solving the Problem

A human resource arrangement apparatus according to a first aspect includes: an acquisition unit configured to acquire a number of tasks and a number of human resources who address the tasks; a calculation unit configured to calculate a result of arranging human resources for each of the tasks to Pareto-optimize a first element and a second element, based at least on a first evaluation value related to the first element to be emphasized when the human resources are arranged for the tasks and a second evaluation value related to the second element that is an element to be emphasized when the human resources are arranged for the tasks and is different from the first element; and an output unit configured to output the arrangement result.

A human resource arrangement method according to a second aspect includes: at an acquisition unit, acquiring the number of tasks and the number of human resources who address the tasks; at a calculation unit, calculating a result of arranging human resources for each of the tasks to Pareto-optimize a first element and a second element, based at least on a first evaluation value related to the first element that is to be emphasized when the human resources are arranged for the tasks and a second evaluation value related to the second element that is an element to be emphasized when the human resources are arranged for the tasks and is different from the first element; and at an output unit, outputting the arrangement result.

### Effects of the Invention

According to the present invention, it is possible to suitably arrange human resources even in a case in which a plurality of elements to be emphasized in arrangement of human resources are in mutually trade-off relationships.

### BRIEF DESCRIPTION OF DRAWINGS

FIG. 1 is a diagram for explaining a concept of one embodiment.

FIG. 2 is a diagram illustrating a configuration in an example of an arrangement apparatus.

FIG. 3 is a diagram illustrating an example of a Pareto optimal solution when weight coefficients satisfy α=1 and β=60.

FIG. 4 is a conceptual diagram of comparison.

FIG. 5 is a flowchart illustrating an example of a learning operation of weight coefficients α* and β* performed by the arrangement apparatus.

FIG. 6 is a diagram illustrating a specific example of comparison.

FIG. 7 is a flowchart illustrating an example of a utilization operation of the weight coefficients α* and β* performed by the arrangement apparatus.

FIG. 8 is a diagram illustrating an input of the arrangement apparatus in an operation example.

FIG. 9A is a diagram illustrating an example of a past arrangement result.

FIG. 9B is a diagram illustrating an example of a past arrangement result.

FIG. 9C is a diagram illustrating an example of a past arrangement result.

FIG. 10A is a diagram illustrating a comparison result between an arrangement result based on mathematical analysis and a past arrangement result.

FIG. 10B is a diagram illustrating a comparison result between an arrangement result based on mathematical analysis and a past arrangement result.

FIG. 10C is a diagram illustrating a comparison result between an arrangement result based on mathematical analysis and a past arrangement result.

FIG. 11 is a diagram illustrating an operation example when the weight coefficients α* and β* are utilized.

### DESCRIPTION OF EMBODIMENTS

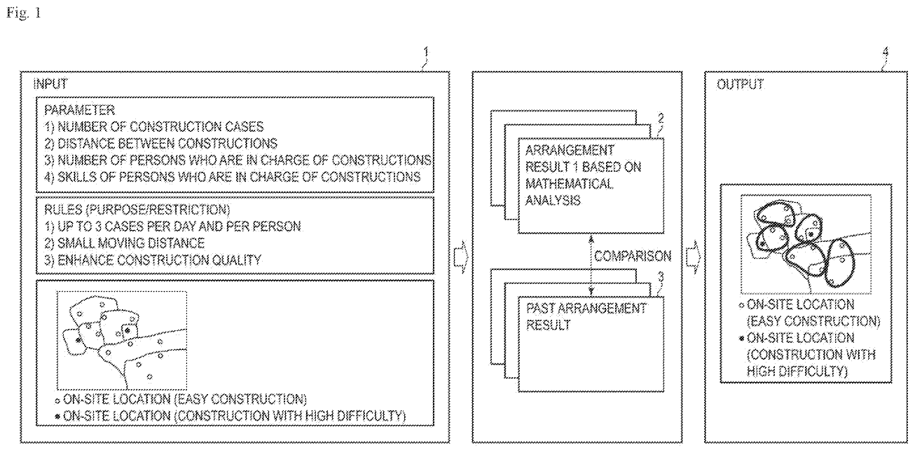

Hereinafter, an embodiment of the present invention will be described based on the drawings. FIG. 1 is a diagram for explaining a concept of one embodiment. A human resource arrangement apparatus according to the embodiment determines arrangement of human resources for each of a plurality of tasks. The tasks include, for example, construction work. Although tasks in the following description of FIG. 1 are assumed to be constructions, the tasks are not limited to construction work.

An input 1 to an arrangement apparatus includes parameters for arranging human resources. The parameters for arranging human resources include, for example, 1) the number of construction cases and 2) distances between constructions. The number of construction cases is a total number of constructions to be assigned to persons who are in charge of the constructions. The distances between constructions are distances between a plurality of construction sites. The distances between construction sites are distances of paths connecting constructions rather than linear distances. Also, the parameters for arranging human resources include 3) the number of persons who are in charge of constructions and 4) skill values of the persons who are in charge of constructions. The number of persons who are in charge of constructions is a total number of persons who are in charge of constructions assigned to the constructions. The skill values are numerical values representing abilities for being in charge of constructions of the persons who are in charge of the constructions. The skill values become better values as the processing times of the constructions become shorter and construction quality becomes higher. The skill values may be values that a decision-making person, such as a person who is in charge of arranging human resources, arbitrarily determines. Also, the skill values may be values determined based on results of tests carried out for the persons who are in charge of constructions, for example.

Also, the input 1 to the arrangement apparatus includes rules for arranging human resources. The rules illustrated in FIG. 1 are that 1) the number of construction cases to be assigned is up to 3 per day and per person, 2) the moving distances of the persons who are in charge of constructions are shortened as much as possible, 3) quality of the constructions are enhanced as much as possible. These rules may be determined by the decision-making person. Also, the number and content of the rules are not limited to those illustrated in FIG. 1.

Also, the input 1 to the arrangement apparatus includes information regarding the constructions. The information regarding the constructions is map image indicating the position and difficulty of each construction, for example. In FIG. 1, the positions of the constructions are information associated with map images and are indicated by positions of points plotted on a map, for example. Also, the difficulties of the constructions are information associated with the map images and are indicated by types of the points plotted on the map. In FIG. 1, the types of the points are categorized into two types, that is, the difficulties of the construction are categorized into two levels. The difficulties of the constructions may be categorized into three or more levels rather than two levels.

The arrangement apparatus determines arrangement of the human resources based on the rules 1), 2), and 3) included in the input 1. Here, how short the moving distances are, which is the rule 2), is determined mainly by the distances between constructions. Also, the quality of constructions, which is the rule 3), is determined mainly by the skill values of the persons who are in charge of the constructions. However, if arrangement of human resources is determined with emphasis placed on how short the distances between constructions are, it is not possible to assign persons who are in charge of constructions with high skills to constructions with higher difficulties in some cases. On the other hand, if arrangement of human resources is determined with emphasis placed on how high construction quality is, there may be a necessity to extend the moving distances of the persons who are in charge of constructions with high skills. In this manner, the moving distances and construction quality are in a trade-off relationship in which they may affect each other. The arrangement apparatus determines arrangement of the human resources to bring the moving distances and the construction quality, which are in trade-off relationships, into a Pareto optimal state. The Pareto optimal state is a state in which other elements have to be worsened in order to improve a certain element from among a plurality of elements.

For example, the arrangement apparatus searches for a Pareto optimal arrangement of human resources by solving a mathematical analysis model defined in advance. Specifically, the arrangement apparatus searches for a result of arranging human resources to minimize an evaluation value that varies depending on the moving distances and the skill values. Typically, a plurality of combinations of moving distances and skill values to minimize the evaluation value are present. Thus, a plurality of Pareto optimal results of arranging human resources are also present. It is possible to state that various kinds of Pareto optimal arrangement of human resources reflect various values of the decision-making person, for example, emphasis being placed on the moving distances, or emphasis being placed on the skill values.

The arrangement apparatus extracts a more suitable arrangement result from among the plurality of results of arranging human resources. Specifically, the arrangement apparatus compares the plurality of arrangement results 2 based on mathematical analysis with past arrangement results 3. Then, the arrangement apparatus extracts the arrangement result 2 with the smallest difference from the past arrangement results 3 from among the arrangement results 2. The past arrangement results 3 are results of arranging human resources created by, for example, the decision-making person. In other words, it is possible to state that the arrangement result 2 with the smallest difference from the past arrangement result 3 is an arrangement result that is closer to an intension of the decision-making person.

After the one arrangement result is extracted, the arrangement apparatus displays an extracted result of arranging the human resources as an output 5 on a display, for example. For example, a result of arranging five persons for fifteen constructions plotted on a map image is illustrated. For example, the arrangement apparatus displays the constructions assigned to one person who is in charge of the construction by surrounding the constructions with circular frames.

In this manner, the arrangement apparatus according to the embodiment calculates the arrangement of the human resources to bring a plurality of elements to be emphasized when the human resources are arranged into a Pareto optimal state, by solving the mathematical analysis model. Also, the arrangement apparatus compares the arrangement result based on the mathematical analysis with a past arrangement result. Then, the arrangement apparatus extracts an arrangement result based on the mathematical analysis with the smallest difference from a past arrangement result. In this manner, according to the embodiment, one arrangement result that is close to the intension of the decision-making person is automatically extracted from a plurality of arrangement results obtained by solving the mathematical analysis model.

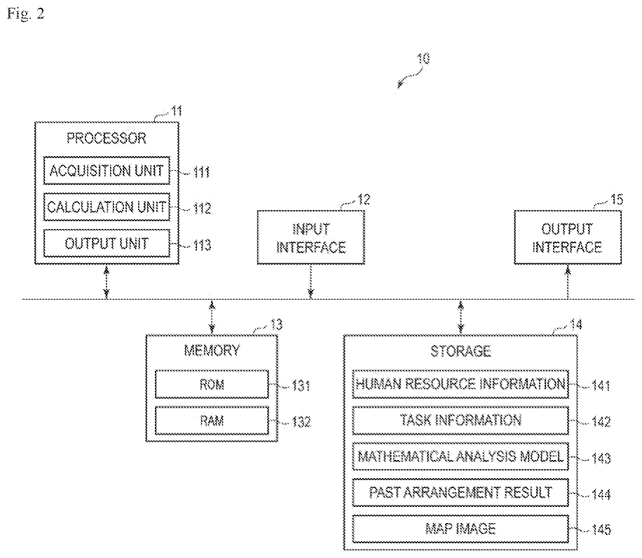

Hereinafter, the arrangement apparatus will be more specifically described. FIG. 2 is a diagram illustrating a configuration of an example of the arrangement apparatus. The arrangement apparatus 10 has a processor 11, an input interface 12, a memory 13, a storage 14, and an output interface 15. The processor 11, the input interface 12, the memory 13, the storage 14, and the output interface 15 are configured to be able to communicate with each other via a bus, for example. The arrangement apparatus 10 may be any of various terminal apparatuses such as a personal computer, a smartphone, and a tablet terminal.

The processor 11 executes various kinds of processing of the arrangement apparatus 10. The processor 11 may be any of various kinds of processors such as a central processing unit (CPU), a micro processing unit (MPU), and a graphics processing unit (GPU). Also, the processor 11 may be an application specific integrated circuit (ASIC), a field programmable gate array (FPGA), or the like. In addition, the processor 11 may be configured with a plurality of CPUs or the like.

The processor 11 has an acquisition unit 111, a calculation unit 112, and an output unit 113. The acquisition unit 111 acquires an input to arrange human resources. The calculation unit 112 searches for Pareto optimal arrangement of human resources by solving the mathematical analysis model. Also, the calculation unit 112 extracts an arrangement result with a small difference from the past arrangement result through comparison between the arrangement results based on the mathematical analysis model and the past arrangement results. The output unit 113 outputs the result of arranging the human resources via the output interface 15. The acquisition unit 111, the calculation unit 112, and the output unit 113 are realized by software executed by the processor 11, for example. The acquisition unit 111, the calculation unit 112, and the output unit 113 may be realized by hardware that is different from the processor 11.

The input interface 12 is an interface used by the decision-making person to provide various inputs to various arrangement apparatuses 10. The input interface 12 may include various input interfaces such as a touch panel, a mouse, and a keyboard. Also, the input interface 12 may include an audio input interface and the like.

The memory 13 is a memory used by the processor 11. The memory 13 includes a read only memory (ROM) 131 and a random access memory (RAM) 132. The ROM 131 stores, for example, a boot program such as a basic input output system (BIOS). The RAM 132 temporarily holds various programs and data generated during execution of the various programs.

The storage 14 is a hard disk drive, a solid state drive, or the like. The storage 14 stores, for example, an OS, various application programs such as a human resource arrangement program, and various kinds of information used when the human resource arrangement program is executed. In the embodiment, the storage 14 stores human resource information 141, task information 142, mathematical analysis model 143, a past arrangement result 144, and a map image 145 as various kinds of information used when the human resource arrangement program is executed. The human resource information 141 is information regarding human resources as targets of arrangement. The human resource information 141 includes numbers for identifying the human resources and skill values of the human resources for each construction, for example. The task information 142 is construction information. The task information 142 includes numbers for identifying constructions and the positions of the construction sites. The mathematical analysis model 143 includes an evaluation equation for calculating Pareto optimal arrangement of human resources. When the weight coefficients α* and β* , which will be described later are determined in advance, the mathematical analysis model 143 includes the weight coefficients α* and β* . The past arrangement result 144 is information of an arrangement table of arranging human resources created in the past, for example. The past arrangement result 144 is stored for each decision-making person. The map image 145 is a map image including positions of the construction sites. Note that the human resource information 141, the task information 142, the mathematical analysis model 143, the past arrangement result 144, and the map image 145 may be stored in a storage device that is different from the arrangement apparatus 10. In this case, the arrangement apparatus 10 acquires information as needed from the storage device.

The output interface 15 is an interface for outputting a result of arranging human resources, for example. The output interface 15 includes a display such as a liquid crystal display, a printer, and the like.

Hereinafter, the calculation unit 112 will further be described. First, a configuration of the calculation unit 112 for searching for Pareto optimal arrangement of human resources will be described. The calculation unit 112 is configured to search for a result of arranging human resources to minimize an evaluation value E of an evaluation equation represented by (Equation 1) below. Hereinafter, such a result of arranging human resources will be referred to as a Pareto optimal solution. As a method for searching for the Pareto optimal solution, an active set method (secondary plan method), for example, is used. As a method for searching for the Pareto optimal solution, the active set method may not be used. In other words, an arbitrary method by which a result of arranging human resources to minimize the evaluation value E can be searched for can be used.

E=αE1+βE2+γE3+ (Equation 1)

Here, E1 is an evaluation value for evaluating a first element to be emphasized in the arrangement of human resources. E1 is, for example, an evaluation value of a moving distance. When E1 is an evaluation value of a moving distance, E1 is calculated based on a total of distances between constructions when some constructions are assigned to all persons who are in charge of constructions as targets of the arrangement. The distances between the constructions may be reduced to 1/10, for example. Also, E2 is an evaluation value for evaluating a second element to be emphasized in the arrangement of human resources. E2 is an evaluation value of construction quality, for example. When E2 is an evaluation value of construction quality, E2 is calculated based on a total of skill values for constructions when some constructions are assigned to all persons who are in charge of constructions as targets of the arrangement. Here, it is assumed that smaller skill values used in (Equation 1) indicate better values. Also, E3 and following values are evaluation values for evaluating third or following elements to be emphasized in the arrangement of human resources. If there are only two elements to be emphasized in the arrangement of human resources as in the example in FIG. 1, for example, E3 and the following values are zero. Hereinafter, the description will be continued on the assumption that E3 and the following values are zero. α is a weight coefficient for the evaluation value E1. β is a weight coefficient for the evaluation value E2. γ and the following values are weight coefficients for the evaluation value E3 and the following values. These weight coefficients correspond to priorities among the elements to be emphasized in the arrangement of human resources.

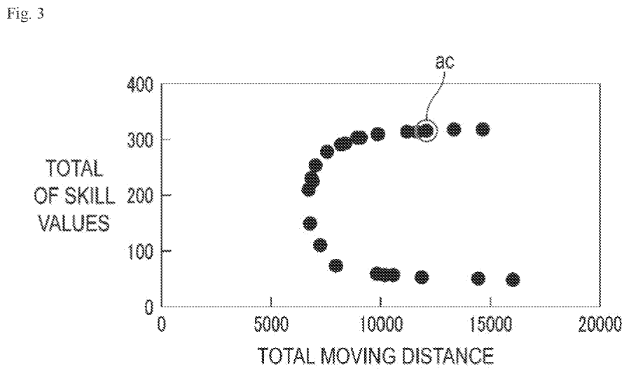

FIG. 3 is a diagram illustrating an example of a Pareto optimal solution calculated by the calculation unit 112 when the weight coefficients satisfy α=1 and β=60. The point ac in FIG. 3 indicates a combination of a total of moving distances and a total of skill values with which a Pareto optimal solution is obtained. FIG. 3 illustrates that the Pareto optimal solution changes depending on how the human resources are arranged even if the weight coefficients α and β are constant. This is because a change in any one of the total of moving distances and the total of skill values depending on how the human resources are arranged leads to a change in the other one. Further, although not illustrated in FIG. 3, the Pareto optimal solution changes depending on a change in weight coefficients α and β as well, as is obvious from (Equation 1).

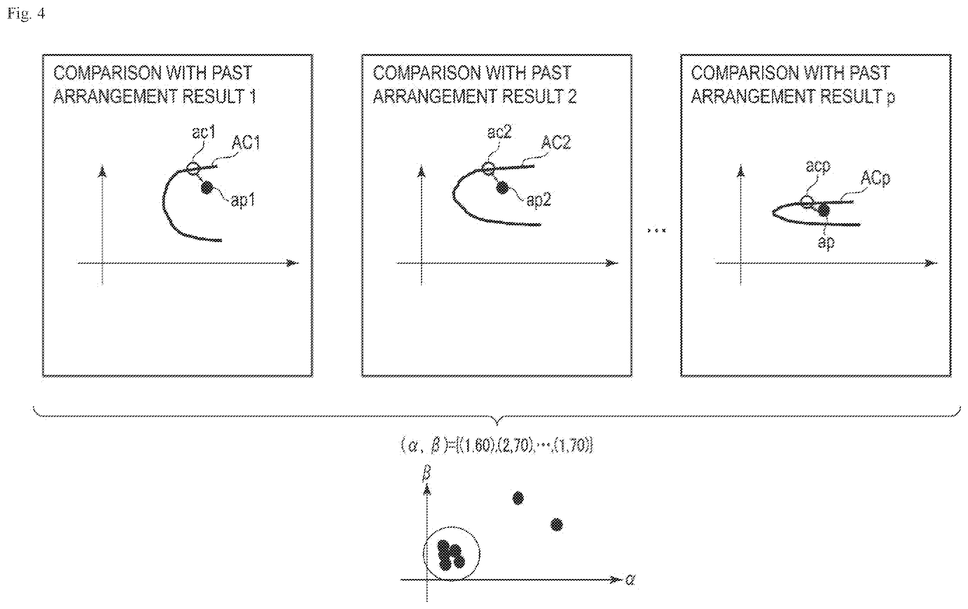

FIG. 4 is a conceptual diagram of comparison performed by the calculation unit 112. As described above, a plurality of Pareto optimal solutions in which how human resources are arranged differs may be present even if the weight coefficients α and β are constant. On the other hand, how to arrange human resources is uniquely determined in the past arrangement result. Thus, a Pareto optimal solution with the smallest difference from the past arrangement result is uniquely determined for certain weight coefficients α and β. Specifically, the past arrangement result and the Pareto optimal solution are compared with each other for each element, and a Pareto optimal solution with the smallest difference for each element is regarded as a Pareto optimal solution with the smallest difference from the past arrangement result.

For example, the point ap 1 in FIG. 4 is a point indicating a total of moving distances and a total of skill values in the first past arrangement result 1. Also, the curve AC1 is a curve indicating a Pareto optimal solution when α=1 and β=60. Any points on the curve AC1 indicate combinations of totals of moving distances and totals of skill values that minimize the evaluation value E in (Equation 1). Here, the Pareto optimal solution having a point closest to the point ap1 is the point ac1 on the curve AC1, for example. In other words, when the weight coefficients satisfy α=1 and β=60, the result of arranging human resources at the point ac1 is the Pareto optimal result of arranging human resources that is closest to the past arrangement result 1.

Similarly, the point ap2 in FIG. 4 is a point indicating a total of moving distances and a total of skill values in the second past arrangement result 2. Also, the curve AC2 is a curve indicating a Pareto optimal solution when α=2 and β=70. Here, the Pareto optimal solution with the closest point to the point ap2 is the point ac2 on the curve AC2, for example. In other words, when the weight coefficients satisfy α=2 and β=70, the result of arranging human resources at the point ac2 is the Pareto optimal arrangement of human resources that is closest to the past arrangement result 2.

Similarly, the point app in FIG. 4 is a point indicating a total of moving distances and a total of skill values in the p-th past arrangement result p. Also, the curve ACp is a curve indicating a Pareto optimal solution when α=1 and β=70. Here, a Pareto optimal solution having the closest point to the point app is the point acp on the curve AC1, for example. In other words, when the weight coefficients satisfy α=1 and β=70, the result of arranging human resources at the point acp is the Pareto optimal result of arranging human resources that is the closest to the past arrangement result p.

As described above, the weight coefficient α is a weight coefficient for an evaluation value of moving distances while the weight coefficient β is a weight coefficient for an evaluation value of skill values. These weight coefficients can be considered as representing an intension of the decision-making person. The calculation unit 112 is configured to identify a trend of a combination between the weight coefficients α and β obtained through the comparison with the past arrangement result by a nearest neighbor identification method, for example. For example, the calculation unit 112 plots, on coordinate axes, a plurality of weight coefficients (α, β) obtained through comparison with the past arrangement result, calculates distances between the points (α, β), and groups the points (α, β) with closest distances. Then, the calculation unit 112 extracts a group including the largest number of points as a group which includes combinations of the weight coefficients α and β that reflect the intension of the decision-making person. Then, the calculation unit 112 regards the smallest weight coefficients α and β, for example, in the group as weight coefficient α* and β* as a combination of the weight coefficients α and β reflecting the intension of the decision-making person. The weight coefficients α* and β* can be used to determine the next arrangement of human resources. The weight coefficients α* and β* may be extracted by any of various methods. For example, weight coefficients α and β corresponding to a center of gravity in the group may be extracted as the weight coefficients α* and β*. Also two or more sets of weight coefficients α and β in the group including the largest number of points may be extracted as the weight coefficients α* and β*.

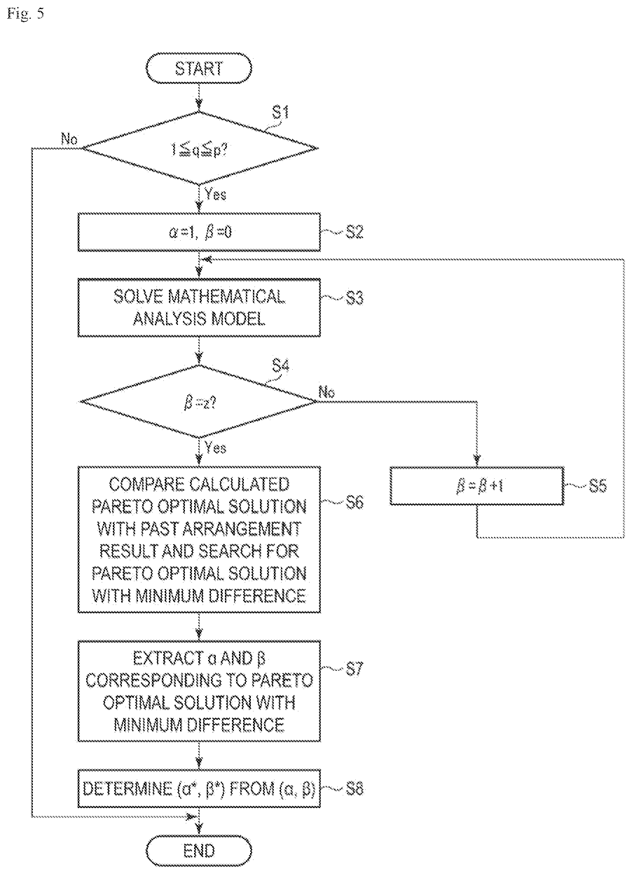

Hereinafter, operations of the arrangement apparatus 10 will be described. FIG. 5 is a flowchart illustrating an example of a learning operation of the weight coefficients α* and β* performed by the arrangement apparatus 10. Here, FIG. 5 illustrates an example of operations when there are two elements to be emphasized in arrangement of human resources. Also, it is assumed that prior to the processing in FIG. 5, various parameters and rules for arranging human resources to be used to arrange human resources have been input through inputs of the decision-making person using the input interface 12.

In Step S1, the processor 11 determines whether or not the number q of past arrangement results of the decision-making person who has tried to arrange human resources falls within a range of 1 to p. When the number q of past arrangement results is determined to fall within the range of 1 to p in Step S1, the processing proceeds to Step S2. When the number q of past arrangement results is determined to be outside the range of 1 to p, that is, when it is determined that the number of the past arrangement results is 0 or the number of the past arrangement results exceeds p in Step S1, the processor 11 causes the processing in FIG. 5 to end. In other words, when past arrangement results are not stored in the storage 14 at all or when the number of past arrangement results stored exceeds the predetermined number, the learning of the weight coefficients α* and β* is not performed.

In Step S2, the processor 11 sets the weight coefficient α to 1 and the weight coefficient β to 0.

In Step S3, the processor 11 calculates each element xᵢⱼₜ*^{p} of the Pareto optimal solution by solving a mathematical analysis model. Here, the subscript i indicates a number (i=1, 2, . . . , n) assigned to each person who is in charge of constructions, j indicates a number (j=1, 2, . . . , m) assigned to each construction, and t indicates a number (t=1, 2, . . . ) assigned to each frame of construction assignment in a case in which a plurality of constructions are assigned to each person who is in charge of the constructions. For example, an element x₁₁₁*^{p}=0 indicates that a construction 1 has not been assigned to the first frame of a person who is in charge of the constructions. For example, an element x₁₅₁*^{p}=1 indicates that a construction 5 has been assigned to the first frame of the person 1 who is in charge of the constructions. For example, an element x₁₄₂*^{p}=1 indicates that a construction 4 has been assigned to the second frame of the person 1 who is in charge of the constructions. As specific processing in Step S3, the processor 11 searches for a result of arranging human resources to minimize the evaluation value E in (Equation 1) while changing a distribution of human resources to the constructions in various manners.

In Step S4, the processor 11 determines whether or not the weight coefficient β has achieved a predetermined value z. The predetermined value z is a maximum value of the weight coefficient β determined in advance. For example, z is set to 100. When the weight coefficient β has not achieved the predetermined value z in Step S4, the processing proceeds to Step S5. When the weight coefficient β has achieved the predetermined value z in Step S4, the processing proceeds to Step S6.

In Step S5, the processor 11 adds 1 to the weight coefficient β. Thereafter, the processor 11 moves on to the processing in Step S3. In other words, the processor 11 solves the mathematical analysis model using the updated weight coefficient β.

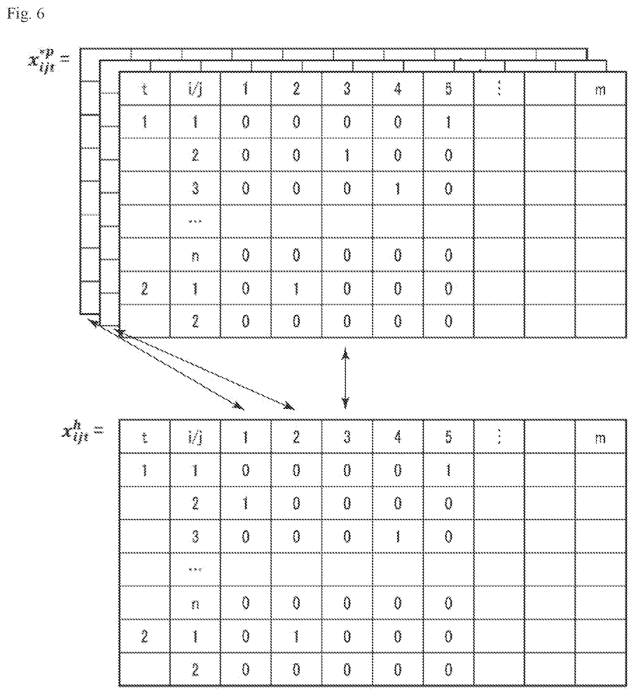

In Step S6, the processor 11 compares the element xᵢⱼₜ*^{p} of each Pareto optimal solution with the element xᵢⱼₜ^{h} of the past arrangement result. Then the processor 11 extracts the Pareto optimal solution with the smallest difference. FIG. 6 is a conceptual diagram of the comparison. In the comparison, a difference of the same elements between the element xᵢⱼₜ^{h} of the past arrangement result and the element xᵢⱼₜ*^{p} of the Pareto optimal solution is calculated. As described above, each element has a value of 0 or 1. Thus, the difference between the element xᵢⱼₜ^{h} of the past arrangement result and the element xᵢⱼₜ*^{p} of the Pareto optimal solution also has a value of 0 or 1. The total of differences of the elements represent a difference between the Pareto optimal and the past arrangement result. In an example of the first (t=1) arrangement result in FIG. 6, the element x₂₁₁^{h} and the element x₂₁₁*^{p} are different from each other, and the element x₂₃₁^{h} and the element x₂₃₁*^{p} are different from each other. Thus, the difference between these arrangement results is 2. Such comparison is performed the number of times corresponding to (the number of combinations of α and β).

In Step S7, the processor 11 extracts the weight coefficients α and β associated with the Pareto optimal solution with the smallest difference from the comparison result in Step S6.

In Step S8, the processor 11 determines the weight coefficients α* and β* a by the nearest neighbor identification method. Then, the processor 11 causes the storage 14, for example, to store the weight coefficients α* and β*. Thereafter, the processor 11 causes the processing in FIG. 5 to end.

Here, in FIG. 5, the processor 11 performs the processing of searching for the Pareto optimal solution while fixing the weight coefficient α to 1 and changing the weight coefficient β in a range of 0 to z. On the contrary, the processor 11 may perform the processing of searching for the Pareto optimal solution while fixing the weight coefficient β to 1 and changing the weight coefficient α in the range of 0 to z. Moreover, the processor 11 may perform the processing of searching for the Pareto optimal solution while changing both the weight coefficient α and the weight coefficient β in the range of 0 to z.

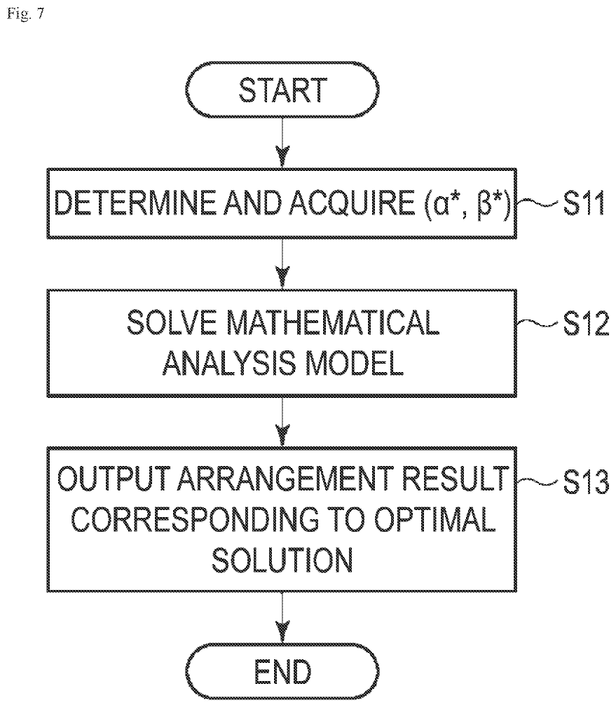

FIG. 7 is a flowchart illustrating an example of utilization operation of the weight coefficients α* and β* performed by the arrangement apparatus 10. Here, FIG. 7 illustrates an example of operations when the number of elements to be emphasized in arrangement of human resources is two. Also, it is assumed that prior to the processing in FIG. 7, various parameters and rules for arranging human resources to be used to arrange human resources have been input through inputs of the decision-making person using the input interface 12.

In Step S11, the processor 11 acquires the weight coefficients α* and β* from the storage 14.

In Step S12, the processor 11 calculates the Pareto optimal solution by solving the mathematical analysis model using an evaluation equation including the weight coefficients α* and β* as weight coefficients. The processor 11 extracts one of a plurality of Pareto optimal solutions. The processor 11 extracts, for example, the first Pareto optimal solution. Also, the processor 11 may extract all the plurality of Pareto optimal solutions as final Pareto optimal solutions. This is because all the plurality of Pareto optimal solutions calculated in Step S12 can be considered as solutions achieved by taking intention of the decision-making person into consideration.

In Step S13, the processor 11 outputs the result of arranging the human resources in accordance with the final Pareto optimal solution via the output interface 15. Thereafter, the processor 11 causes the processing in FIG. 7 to end. For example, the processor 11 displays a map image on the display and further displays the result of arranging the human resources on the map image as illustrated in FIG. 1.

Hereinafter, a specific example of operations performed by the arrangement apparatus 10 will be described. In the following operation example, an example in which three persons who are in charge of constructions, namely Person A, Person B, and Person C are arranged for six different constructions, namely Constructions 1 to 6 is illustrated. Two constructions are assigned to one person who is in charge of the constructions.

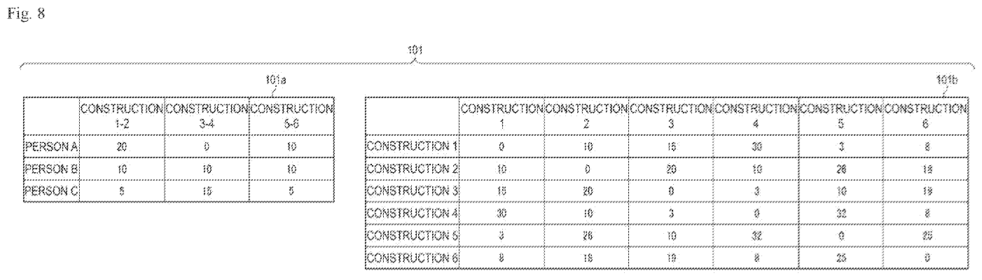

FIG. 8 is a diagram illustrating an input 101 of the arrangement apparatus 10 in the operation example. As illustrated in FIG. 8, the input 101 includes a moving distance table 101a and a skill value table 101b. The moving distance table 101a and the skill value table 101b may be created on the basis of an input of the decision-making person using the input interface.

The moving distance table 101a is a table for moving distances between constructions. Each row in the moving distance table 101a indicates the number of construction at a current location. Each column in the moving distance table 101a indicates the number of construction at a destination. A numerical value in each cell in the moving distance table 101a indicates the distance between constructions from the construction site at the current location to the construction site at the destination. The numerical value in each cell in FIG. 8 is reduced to 1/10 from the actual distance.

The skill value table 101b is a table for skill values of the persons who are in charge of the constructions. Each row in the skill value table indicates a name of the person who is in charge of the constructions. The name of the person who is in charge of the constructions may be replaced with a number or the like. Also, each column in the skill value table represents the number of construction. A numerical value in each cell in the skill value table 101b indicates a processing ability of the person who is in charge of the construction to address the construction. Here, smaller skill values indicate higher processing abilities of addressing the constructions. It is assumed that in FIG. 8, Constructions 1 and 2 are constructions with the same difficulty, Constructions 3 and 4 are constructions with the same difficulty, and Constructions 5 and 6 are constructions with the same difficulty. Thus, the skill values for Constructions 1 and 2 are a common value, the skill values for Constructions 3 and 4 are a common value, and the skill values for Constructions 5 and 6 are a common value. It is a matter of course that the skill value table 101b may independently have skill values for Constructions 1 to 6.

A Pareto optimal solution that minimizes the evaluation value E in the evaluation equation represented by (Equation 1) is calculated using the moving distance table 101a and the skill value table 101b illustrated in FIG. 8. It is assumed that when α=0 and β=1, for example, the processor 11 assigns Person A to Constructions 1 and 5. The distance between the constructions in this case is “3”, which is the distance between constructions, namely from Construction 1 to Construction 5. Similarly, it is assumed that the processor 11 assigns Person B to Constructions 2 and 4. The distance between the constructions in this case is “10”, which is the distance between constructions, namely from Construction 2 to Construction 4. Similarly, it is assumed that the processor 11 assigns Person C to Constructions 3 and 6. The distance between the constructions in this case is “19”, which is the distance between constructions, namely from Construction 3 to Construction 6. Thus, the evaluation value E satisfies E=0+1×(3+10+19)=32. A result of arranging human resources that minimizes the evaluation value E is searched for by repeating such processing. In practice, a result of arranging human resources is searched for by the active set method.

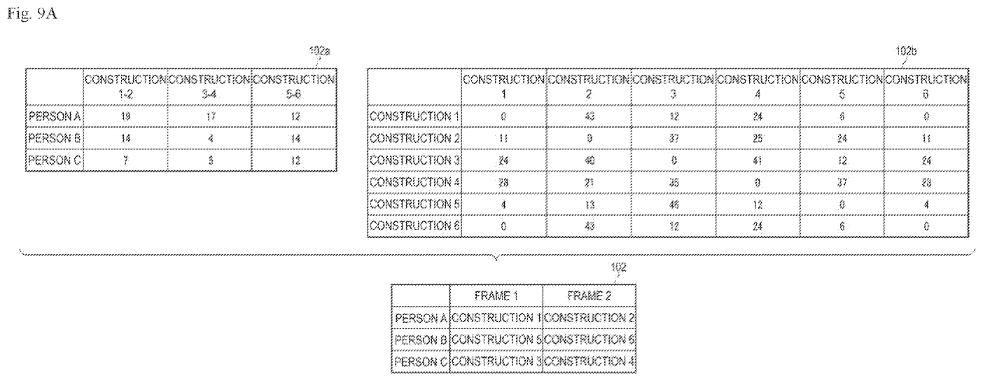

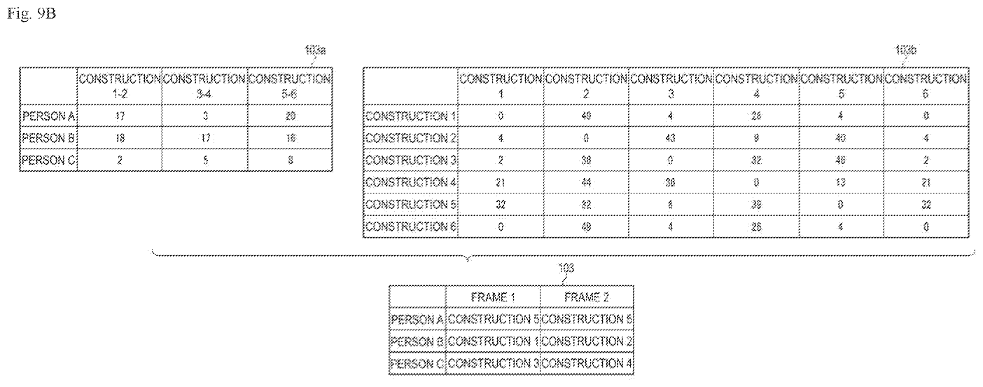

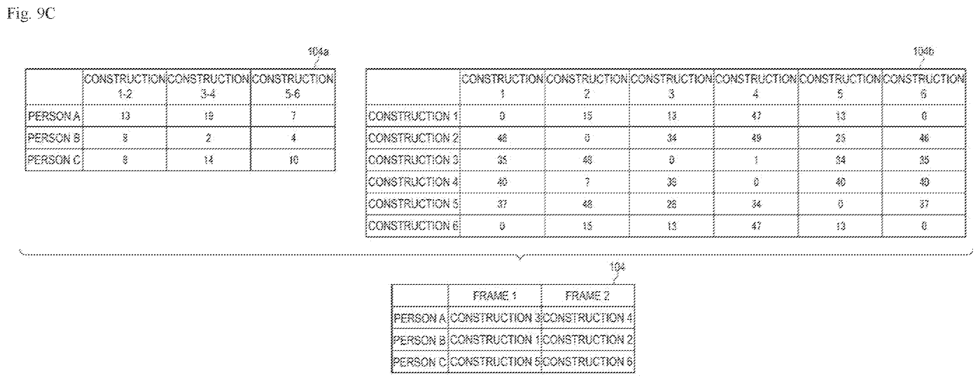

FIGS. 9A, 9B, and 9C are examples of past arrangement results. FIG. 9A illustrates that the decision-making person creates a past arrangement result 102 using a moving distance table 102a and a skill value table 102b. FIG. 9B illustrates that the decision-making person creates a past arrangement result 103 using a moving distance table 103a and a skill value table 103b. FIG. 9C illustrates that the decision-making person creates a past arrangement result 104 using a moving distance table 104a and a skill value table 104b. These past arrangement results are stored in advance in the storage 14.

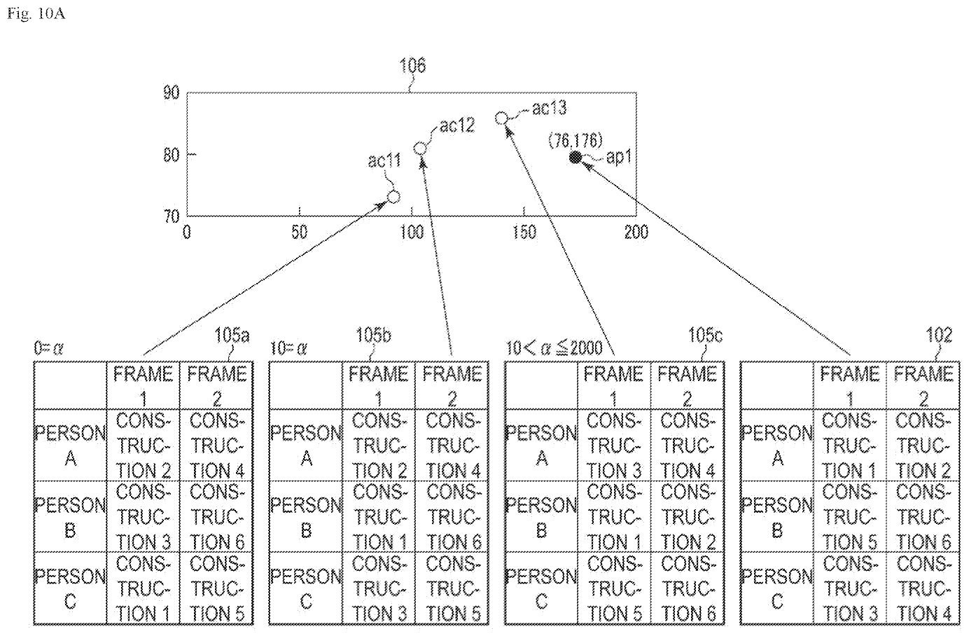

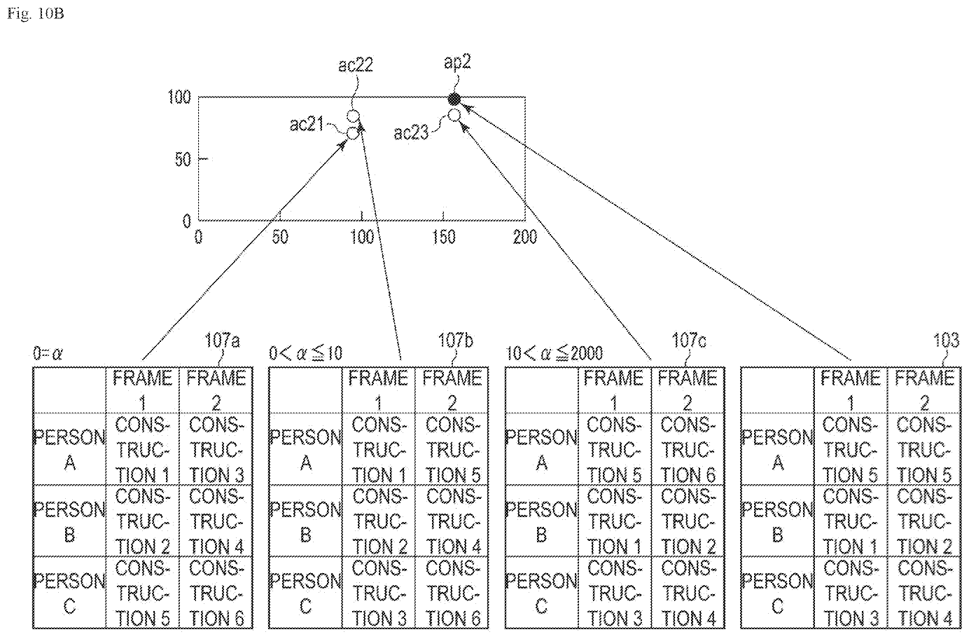

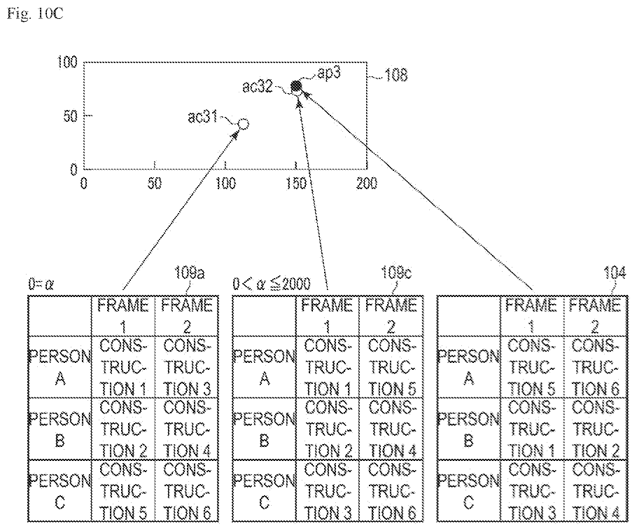

FIG. 10A is a diagram illustrating a comparison result between an arrangement result based on mathematical analysis and the past arrangement result 102 when the weight coefficient β is fixed to 1, for example, and the weight coefficient α is changed between 0 and 2000. When the weight coefficient α is 0, arrangement of human resources is determined in accordance only with the skill values. In this case, the arrangement of human resources is determined to minimize the total of the skill values. As a result, an arrangement result 105a, for example, is obtained. On the other hand, in a case in which the weight coefficient α is sufficiently large, the skill values have less influences while the moving distances have more influences. In practice, there is a limit for arranging human resources. Thus, the arrangement result does not necessarily change even if the weight coefficient α changes. In the example in FIG. 10A, the arrangement result obtained when the weight coefficient α is 10 is, for example, an arrangement result 105b. Also, an arrangement result obtained when the weight coefficient α satisfies 10<α≤2000 is, for example, an arrangement result 105c.

In the coordinate plane 106 in FIG. 10A, the point ap1 representing a set of the total of the moving distances and the total of the skill values corresponding to the past arrangement result 102 is plotted. Also, the point ac11, the point ac12, and the point ac13 that represents a set of the total of the moving distance and the total of the skill values corresponding to the arrangement result 105c are also plotted in the coordinate plane 106. The point ac11 represents a set of the total of the moving distances and the total of the skill values corresponding to the arrangement result 105a. The point ac12 represents a set of the total of the moving distances and the total of the skill values corresponding to the arrangement result 105b.

In the example in FIG. 10A, the Pareto optimal solution and the past arrangement result 102 are compared with each other among different weight coefficients α. For example, a difference between the arrangement result 105a and the past arrangement result 102 is 5, a difference between the arrangement result 105b and the past arrangement result 102 is 4, and a difference between the arrangement result 105c and the past arrangement result 102 is 6. Thus, the difference between the arrangement result 105b and the past arrangement result 102 is the minimum in the example in FIG. 10A. In this case, the weight coefficient α=10 is estimated to be the weight coefficient α representing the intension of the decision-making person.

FIG. 10B is a diagram illustrating a comparison result between an arrangement result based on mathematical analysis and the past arrangement result 103 when the weight coefficient β is fixed to 1, for example, and the weight coefficient α is changed between 0 and 2000.

In FIG. 10B, the point ap2 representing a set of the total of the moving distances and the total of the skill values corresponding to the past arrangement result 103 is plotted in the coordinate plane 106. Also, the point ac21, the point ac22, and the point ac23 are also plotted in the coordinate plane 106. The point ac21 represents a set of a total of moving distances and a total of skill values corresponding to an arrangement result 107a, which is a Pareto optimal value obtained when the weight coefficient α is 0 and has the smallest difference from the past arrangement result 103. The point ac22 represents a set of a total of moving distances and a total of skill values corresponding to an arrangement result 107b, which is a Pareto optimal solution obtained when the weight coefficient α satisfies 0<α≤10 and has the smallest difference from the past arrangement result 103. The point ac23 represents a set of a total of moving distances and a set of skill values corresponding to an arrangement result 107c, which is a Pareto optimal solution obtained when the weight coefficient α satisfies 10<α≤2000 and has the smallest difference from the past arrangement result 103.

The Pareto optimal solution and the past arrangement result 102 are compared with each other among different weight coefficients α in the example in FIG. 10B as well. For example, a difference between the arrangement result 107a and the past arrangement result 103 is 6, a difference between the arrangement result 107b and the past arrangement result 103 is 4, and a difference between the arrangement result 107c and the past arrangement result 102 is 1. Thus, the difference between the arrangement result 107c and the past arrangement result 103 is the minimum in the example in FIG. 10B. In this case, the weight coefficient α within the range of 10<α≤2000 is estimated as the weight coefficient α representing the intension of the decision-making person.

FIG. 10C is a diagram illustrating a comparison result between an arrangement result based on mathematical analysis and the past arrangement result 104 when the weight coefficient is fixed to 1, for example, and the weight coefficient α is changed between 0 and 2000.

In FIG. 10C, the point ap3 representing a total of moving distances and a total of skill values corresponding to the past arrangement result 104 is plotted in the coordinate plane 106. Also, the point ac31 and the point ac32 are also plotted in the coordinate plane 108. The point ac31 represents a set of a total of moving distances and a total of skill values corresponding to an arrangement result 109a, which is a Pareto optimal solution obtained when the weight coefficient α is 0 and has the minimum difference from the past arrangement result 104. The point ac32 represents a set of a total of moving distances and a total of skill values corresponding to an arrangement result 109b, which is a Pareto optimal solution obtained when the weight coefficient a satisfies 0<α≤2000 and has the minimum difference from the past arrangement result 104.

The Pareto optimal solution and the past arrangement result 104 are compared with each other among different weight coefficients α in the example in FIG. 10C as well. For example, a difference between the arrangement result 109a and the past arrangement result 104 is 6, and a difference between the arrangement result 109b and the past arrangement result 104 is 0. Thus, the difference between the arrangement result 109b and the past arrangement result 104 is the minimum in the example in FIG. 10B. In this case, the weight coefficient α within the range of 0<α≤2000 is estimated as the weight coefficient α representing the intension of the decision-making person.

Based on the results in FIGS. 10A, 10B, and 10C, the weight coefficient α* representing the intension of the decision-making person is estimated as 10 by the nearest neighbor identification method. On the other hand, the weight coefficient β* is the aforementioned fixed value, for example, 1.

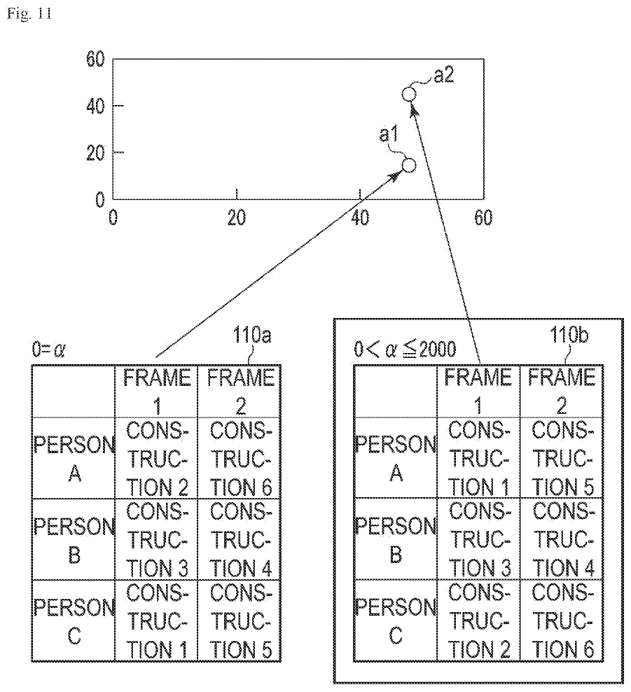

FIG. 11 is a diagram illustrating an operation example when the weight coefficients α* and β* are utilized. Note that the input is assumed to be the same as that in FIG. 8. An arrangement result 110b instead of the arrangement result 110a is output in the example in FIG. 11 by searching for the Pareto optimal solution using the weight coefficients α* and β*. A point a2 representing a set of a total of moving distances and a total of skill values corresponding to the arrangement result 110b is located to be close to a point representing a set of a total of moving distances and a total of skill values corresponding to the past arrangement result with a higher probability than a point a1 representing a set of a total of moving distances and a total of skill values corresponding to the arrangement result 110a. In other words, the arrangement result 110b can be considered to reflect the intension of the decision-making person.

As described above, according to the embodiment, a result of arranging human resources is determined to bring a plurality of elements to be emphasized in regard to the arrangement of the human resources into a Pareto optimal state. In this manner, a result of suitably arranging human resources is automatically determined even if there arc a plurality of elements in trade-off relationships. This reduces a burden on the decision-making person.

Also, according to the embodiment, an evaluation value for searching for the Pareto optimal solution is weighted. A unique Pareto optimal solution reflecting the intension of the decision-making person is automatically searched for by determining the weights through comparison with the past arrangement result performed by the decision-making person.

Also, in the embodiment, the Pareto optimal solution is searched for with only one of the plurality of weight coefficients changed in the searching for the Pareto optimal solution. This reduces the amount of calculation. Thus, the burden on the processor 11 is reduced.

Here, the arrangement of human resources is determined based on two elements, namely the moving distances and the skill values in the aforementioned embodiment. As represented by (Equation 1), the number of the elements is not limited to two. Even when the number of the elements is three or more, the arrangement of human resources may be determined to bring the three elements into a Pareto optimal state, that is, to minimize the evaluation value E in (Equation 1).

Also, the arrangement result is not output to the output interface 15 in the example in FIG. 5. On the other hand, when the Pareto optimal solution with the smallest difference from the past arrangement result is extracted in Step S6, the Pareto optimal solution may be directly output as an arrangement result to the output interface 15.

The present invention is not limited to the above embodiment as it is and can be implemented with the components modified without departing from the gist thereof in the stage of implementation. Furthermore, various inventions can be formed by appropriately combining the plurality of components disclosed in the above embodiment. For example, some components may be deleted from all the components illustrated in the embodiment. Furthermore, components in different embodiments may be appropriately combined with each other.

Also, the processing in the aforementioned embodiment can also be stored as a program that a processor, which is a computer, can be caused to execute. In addition, the processing can be stored and distributed in a storage medium of an external storage device such as a magnetic disk, an optical disc, or a semiconductor memory. Then, the processor can execute the aforementioned processing by reading the program stored in the storage medium of the external storage device and by the read program controlling operations. Also, artificial intelligence may be used to search for a Pareto optimal solution using the active set method and to search for the weight coefficients using the nearest neighbor identification method described above.

### REFERENCE SIGNS LIST

10 Arrangement apparatus
11 Processor
12 Input interface
13 Memory
14 Storage
15 Output interface
111 Acquisition unit
112 Calculation unit
113 Output unit

1. A human resource arrangement apparatus comprising:
a processor; and
a storage medium having computer program instructions stored thereon, when executed by the processor, perform to:
acquire the number of tasks and the number of human resources who address the tasks;
calculate a result of arranging human resources for each of the tasks to Pareto-optimize a first element and a second element, based at least on a first evaluation value related to the first element to be emphasized when the human resources are arranged for the tasks and a second evaluation value related to the second element that is an element to be emphasized when the human resources are arranged for the tasks and is different from the first element; and
output the arrangement result.

2. The human resource arrangement apparatus according to claim 1,
wherein the first evaluation value is weighted with a first weight coefficient,
the second evaluation value is weighted with a second weight coefficient, and
the computer program instructions further perform to calculates a plurality of first arrangement results that are results of arranging human resources for each task to Pareto-optimize the first element and the second element, using each of a plurality of different combinations of the first weight coefficient and the second weight coefficient,
compares the first arrangement results with at least one second arrangement result created in the past, and
determines a combination of the first weight coefficient and the second weight coefficient in accordance with a result of the comparison.

3. The human resource arrangement apparatus according to claim 2, wherein the computer program instructions further perform to calculates the first arrangement results while fixing the first weight coefficient and changing the second weight coefficient.

4. The human resource arrangement apparatus according to claim 2, wherein the computer program instructions further perform to determines a final combination of the first weight coefficient and the second weight coefficient based on a plurality of combinations of the first weight coefficient and the second weight coefficient corresponding to the first arrangement results with small differences from the plurality of second arrangement results.

5. A human resource arrangement method comprising:
at an acquisition unit, acquiring the number of tasks and the number of human resources who address the tasks;
at a calculation unit, calculating a result of arranging human resources for each of the tasks to Pareto-optimize a first element and a second element, based at least on a first evaluation value related to the first element that is to be emphasized when the human resources are arranged for the tasks and a second evaluation value related to the second element that is an element to be emphasized when the human resources are arranged for the tasks and is different from the first element; and
at an output unit, outputting the arrangement result.

6. A human resource arrangement program configured to cause a processor to function as human resource arrangement apparatus according to claim 1.
